(19) United States
(12) Patent Application Publication
(10) Pub. No.: US 2020/0162489 A1
(43) Pub. Date: May 21, 2020

(54) SECURITY EVENT DETECTION AND THREAT ASSESSMENT

(71) Applicant: Airspace Systems, Inc., San Leandro, CA (US)

(72) Inventors: Guy Bar-Nahum, Sausalito, CA (US); Aislan Gomide Foina, El Cerrito, CA (US)

(21) Appl. No.: 16/684,003

(22) Filed: Nov. 14, 2019

Related U.S. Application Data
(60) Provisional application No. 62/768,652, filed on Nov. 16, 2018.

(51) Int. Cl. H04L 29/06; G06N 20/00

(52) U.S. Cl. CPC H04L 63/1416; H04L 63/1433; G06N 20/00

(57) ABSTRACT

An indication of a detected security event is received. One or more sensors are selected based on the detected security event. The selected sensors are used to detect additional information associated with a protected airspace associated with the detected security event. A risk level assessment associated with the detected security event is determined based at least in part on the additional information detected using the selected sensors. A response is automatically invoked based on the determined risk level assessment.

### CROSS REFERENCE TO OTHER APPLICATIONS

This application claims priority to U.S. Provisional Patent Application No. 62/768,652 entitled DRONE DETECTION AND THREAT ASSESSMENT filed Nov. 16, 2018 which is incorporated herein by reference for all purposes.

### BACKGROUND OF THE INVENTION

A security event may be detected by a sensor. An initial location of the security event may be determined based on the sensor data. For example, a radar sensor may determine that a security event occurred within a detection cone. However, the initial location information may not be sufficient to determine the actual location of the security event. In some situations, time is of the essence when determining the actual location of the security event. For example, the security event may be a pipeline explosion, an unauthorized use of an unmanned aerial vehicle, a shooting, etc. Some systems may send out a response team comprised of one or more individuals to determine the actual location of the security event. However, such a response may lead to a delay in a determination of the actual location of the security event because the search area in which the response team is searching is too large to quickly locate the security event. A swift response to the actual location of the security event may prevent and/or reduce the amount of property damage, loss of human life, or prevent criminal activity. The ability to quickly respond to potential security event depends on the granularity of the location data associated with the sensor.

### BRIEF DESCRIPTION OF THE DRAWINGS

Various embodiments of the invention are disclosed in the following detailed description and the accompanying drawings.

FIG. 1 is a block diagram illustrating an embodiment of a system for detecting security events.

FIG. 2 is a flow chart illustrating an embodiment of a process for responding to a detected security event.

FIG. 3 is a flow chart illustrating an embodiment of a process for joining a network of sensors.

FIG. 4 is a flow chart illustrating an embodiment of a process for generating a database of sensor information.

FIG. 5 is a flow chart illustrating an embodiment of a process for selecting one or more sensors.

FIG. 6 is a flow chart illustrating an embodiment of a process for detecting a security event.

FIG. 7 is a flow chart illustrating an embodiment of a process for determining a risk assessment associated with a detected security event.

FIG. 8 is an example of a user interface in accordance with some embodiments.

FIG. 9 is a block diagram illustrating an embodiment of an unmanned aerial vehicle.

FIG. 10 is a flow chart illustrating an embodiment of a process for capturing a target object.

FIG. 11 is a block diagram illustrating an embodiment of a system for managing an airspace.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

A security event detection system, described herein, may accurately determine the location of a security event and upon determining that the security event poses a security risk, enable a swift response to the actual location of the security event. The security event detection system may be comprised of a first layer of sensors and a second layer of sensors. The first layer of sensors is comprised of a first plurality of sensors. Examples of sensors included in the first layer of sensors include, but are not limited to, RADAR sensors, LIDAR sensors, acoustic wave sensors, microphone array, mesh network of sensors, RF sensors, cameras, third party systems, etc. A sensor in the first layer of sensors may be omni-directional with respect to a detection area. The first layer of sensors may be located throughout an area to provide detection coverage for corresponding portions of the area.

For example, a detected security event may be the detection of an unmanned aerial platforms, including unmanned aerial vehicles (UAV) and aerial drones. Some applications may pose a risk to people or property. Unmanned Aerial Vehicles and Aerial Drones are herein referred to collectively as UAVs. UAVs have been used to carry contraband, including drugs, weapons, and counterfeit goods across international borders. It is further possible that UAVs may be used for voyeuristic or industrial surveillance, to commit terrorist acts such as spreading toxins or transporting an explosive device. In view of this risk posed by malicious UAVs, it may be necessary to have a system to detect, monitor, track, classify, and/or assess a UAV that has entered a restricted area, such as a protected airspace. For example, a user interface may provide a visual indication of current and past locations of detected UAVs as well their trajectories and corresponding threat level classification ranking (e.g., determined using a machine learning trained model). The user interface may also provide a visual indication of a location of an operator of a UAV (e.g., by detecting and locating source of RF control signal sent by the UAV operator).

Upon detecting a security event, a sensor included in the first layer of sensors may output a value indicating an initial location of the security event. The output from the first layer of sensors may not be precise enough to determine the actual location of the security event. One or more subsequent scans may be performed using one or more of the sensors included in the first layer of sensors to refine the location of the security event, however, the one or more subsequent scans may be too time-consuming to determine the actual location of the security event or unable to determine the actual location of the security event.

The location data outputted by at least one of the sensors included in the first layer of sensors may be provided to a security event detection system, which may use the location data to select one or more sensors included in a second layer of sensors to determine a refined location of the security event. A refined location of the security event is a more accurate location of the security event. For example, the first layer of sensors may indicate that a security event is detected in a general area (e.g., one mile from point A). A refined location may indicate within the general area where the security event is located (e.g., at location (x, y, z)). The second layer of sensors is comprised of a second plurality of sensors. Examples of sensors included in the second layer of sensors include, but are not limited to, cameras, image sensors, unmanned aerial vehicles (UAVs) equipped with detection sensors, directional sensor, RF sensor, infrared sensor, etc. In some embodiments, a sensor included in the second layer of sensors may act as a sensor in the first layer of sensors, and vice versa. The second layer of sensors may be located throughout the area to provide detection coverage for corresponding portions of the area. A sensor included in the second layer of sensors may be directional with respect to a detection area. The coverage area associated with a sensor included in the second layer of sensors may be less than the coverage area associated with a sensor included in the first layer of sensors. The sensors included in the second layer of sensors may be stationary (e.g., attached to a permanent structure) or moving (e.g., attached to a vehicle).

Each of the sensors included in the second layer of sensors may be registered with the security event detection system. The security event detection system may store sensor information associated with each registered sensor. Sensor information may include detection range, detection resolution, detection type, detection angle, detection pitch, the existence of any occlusions, availability information (in use, not in use), power information (plug in or battery powered), sensor location, etc. The security event detection system may store a sensor information database that includes a plurality of entries, each entry associated with one of the registered sensors. The security event detection system may scan the plurality of entries to identify one or more sensors that have a capability to detect the potential security event based on the location information provided by the at least one sensor included in the first layer of sensors. A sensor may have a capability to detect the security event in the event the sensor information associated with the sensor indicates that the security event is within a detection range of the sensor, within a detection angle/pitch of the sensor, and/or no occlusions prevent the sensor from detecting the security event.

The security event detection system may use the location information outputted by at least one of the sensors included in the first layer of sensors to select a primary sensor included in the second layer of sensors. In some embodiments, the security event detection system selects one or more secondary sensors included in the second layer of sensors. The primary and the one or more secondary sensors may be selected based on one or more factors. The one or more factors may include whether a sensor is currently available, whether the location information outputted by at least one of the sensors included in the first layer of sensors is within a detection range of a sensor included in the second layer of sensors, detection resolution of the sensor, is capable of moving with a detection area associated with a detection sensor included in the first layer of sensors, is capable of being adjusted to focus in the detection area associated with the detection sensor included in the first layer of sensors, within a detection angle/pitch of the sensor, and/or the existence of any occlusions. A sensor may be near the detected security event (e.g., within 50 feet), but unable to detect the security event because the sensor is pointed in the wrong direction. Such a sensor would not be selected to detect the security event. A sensor may be far from the detected security event (e.g., 2 miles), but able to detect the security event because the initial location of the security event is within a detection zone (e.g., within a detection range and within a detection angle/pitch of the sensor) associated with the sensor. Such a sensor may be selected as a primary sensor or a secondary sensor.

The security event detection system may activate the one or more selected sensors. In some embodiments, a position of a selected sensor is adjusted. For example, a detection view of a camera may be adjusted to point in a direction of the initial location of the detected security event. In some embodiments, a detection range of a selected sensor is adjusted. For example, a detection view of a camera may be zoomed/focused into a portion of its detection range. Upon activation, the one or more selected sensors may be used to detect a refined location of the detected security event. For example, an image sensor may detect the security event within its field of view. At least one of the selected sensors may determine additional information associated with the detected security event. For example, the additional information may include the nature of a detected security event (e.g., pipeline explosion, an unauthorized use of an unmanned aerial vehicle, a shooting). The additional information may include whether the detected security event is stationary or moving. The additional information may include object identification information associated with a detected security event, such as make and model of a vehicle, type of UAV, identification of one or more individuals associated with the detected security event. For example, the image sensor may be coupled to an image classifier that is trained to classify detected objects associated with the detected security event. One of the selected sensors may be able to detect a location of an operator of a UAV associated with the detected security event and the additional information may include a location of an operator of a UAV that is associated with the detected security event. The additional information may include the speed of an object associated with the detected security event, a trajectory of an object associated with the detected security event, or a path of the object associated with the detected security event. The additional information may include refined location information associated with the detected security event (e.g., coordinates of the detected security event). The refined location information may be a real-time location of the detected security event. For example, one of the sensors may track the location of an object associated with the detected security event as the object is moving.

The security event detection system may use the additional information detected by at least one of the selected sensors to determine a risk level assessment associated with the detected security event. The security event detection system may include a machine learning model. A feature vector may be applied to the machine learning model. The feature vector may be comprised of a plurality of elements. Each element may correspond to a feature associated with a security event. A feature value may be based directly or indirectly on the additional information obtained by the one or more selected sensors. In response to the feature vector being applied to the machine learning model, the machine learning model may be configured to output a value that indicates a threat level associated with the detected security event. The one or more feature values may be applied to one or more risk assessment rules. An output of a risk assessment rule may indicate whether a detected security event is a security risk.

The security event detection system may be configured to automatically invoke a response for the detected security event based on an output of the machine learning model and/or an output of the one or more risk assessment rules. The detected security event may be classified as a “low security risk,” “medium security risk,” or a “high security risk” based on the output of the machine learning model. The security event detection system may automatically invoke a response that corresponds to the determined security risk. For example, the security event detection system may perform or cause to perform a first type of response in the event the detected security event is classified as a “low security risk,” a second type of response in the event the detected security event is classified as a “medium security risk,” and a third type of response in the event the detected security event is classified as a “high security risk.” In some embodiments, an interdiction system is activated. In some embodiments, a response team is notified with the refined location of the detected security event. In some embodiments, a jamming signal is transmitted to disable a UAV associated with the detected security event. In some embodiments, a notification is provided to an administrative team associated with a protected airspace.

By using a combination of a first layer of sensors to detect an initial location of a security event a second layer of sensors to refine the initial location into a refined location of the security event, the amount of time between detection and response is reduced. This may prevent and/or reduce the amount of property damage, loss of human life, or prevent criminal activity.

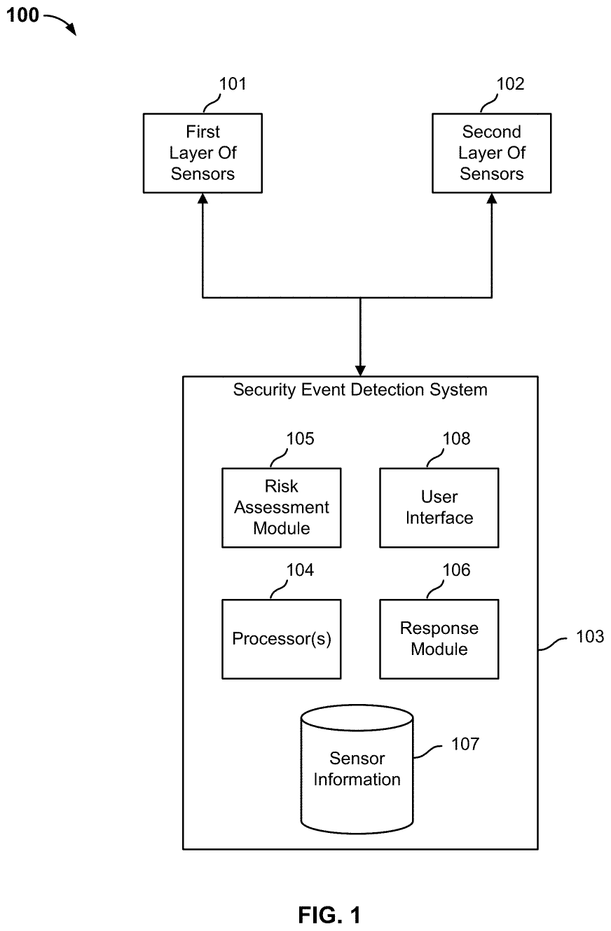

FIG. 1 is a block diagram illustrating an embodiment of a system for detecting security events. In the example shown, system 100 is comprised of a first layer of sensors 101, a second layer of sensors 102, and a security event detection system 103.

The first layer of sensors 101 may be comprised of n sensors. Examples of sensors included in the first layer of sensors include, but are not limited to, RADAR sensors, LIDAR sensors, acoustic wave sensors, a microphone array, mesh network of sensors, pressure sensors, vibration sensors, chemical sensors, environmental sensors, thermal sensors, heat sensors, temperature sensors, speed sensors, etc. The first layer of sensors 101 is comprised of different types of sensors to provide different types of coverage for different types of security events. Each of the sensors included in the first layer of sensors 101 may be registered with security event detection system 103. Sensor information associated with a sensor may be included in a registration and stored in sensor information database 107. The sensor information may include a location associated with a sensor, a sensor type associated with a sensor, a detection range associated with a sensor, a name associated a sensor, a manufacturing brand associated with a sensor, etc.

Each sensor of the first layer of sensors 101 may be located at a different position of an area. In some embodiments, the sensors of the first layer of sensors 101 provide overlapping coverage with each other. In some embodiments, at least one of the sensors of the first layer of sensors 101 does not overlap in coverage with another sensor of the first layer of sensors 101. In some embodiments, at least one of the first layer of sensors 101 is associated with a protected airspace. For example, one of the first layer of sensors 101 may be located at or near a protected airspace, such as an airport, military base, a stadium, an arena, a railroad station, a subway station, a museum, a historical landmark, a bridge, a commercial building, a government building, etc. In some embodiments, a protected airspace is a permanent protected airspace. In other embodiments, a protected airspace is a temporary protected airspace. For example, an area may be a temporary protected airspace for a particular time range on a particular day (8 am-6 pm), on a particular day of the week (every Saturday), for a particular range of weeks (e.g., first week of August until the second week of September), for a particular range of months (e.g., holiday season), etc. A sensor of the first layer of sensors 101 may be attached to a structure, such as a building, a stand-alone sensor, on the road, on a vehicle, etc.

A sensor of the first layer of sensors 101 may detect a security event. Examples of security events include, but are not limited to, a pipeline explosion, an unauthorized use of an unmanned aerial vehicle, a shooting, etc. A security event may have an associated detection signature. For example, a pipeline explosion may emit an odor having a particular chemical composition that may be detected by a particular sensor. An unmanned aerial vehicle may output a frequency that may be detected by a particular sensor. The shooting of a gun may have a particular sound frequency that may be detected by a particular sensor. A sensor of the first layer of sensors 101 may detect a security event based on a detection signature associated with the security event.

In response to detecting a security event, at least one of the first layer of sensors 101 may provide to security event detection system 103 an indication of the detected security event. The indication may include an initial location of the sensor that detected the security event. The indication may also include an estimated location of the detected security event. For example, a radar sensor may provide a detection cone in which the security event was detected. In response to detecting a security event, such as a gunshot, an acoustic sensor may provide to security event detection system 103, its location. The location of the acoustic sensor may not be the actual location of the detected security event because the origin of the gunshot may be located near the acoustic sensor, but the location of the acoustic sensor provides a general location of the detected security event (e.g., at a location within a detection range of the acoustic sensors). The indication may include other information associated with the detected security event, such as a timestamp associated with the detection, a type of sensor used to detect the security event, detection signature detected, type of security event detected, etc.

In response to receiving the indication, security event detection system 103 may select one or more of the sensors included in the second layer of sensors 102. The information included in the indication may provide an initial location of the detected security event. Some systems may send out a response team comprised of one or more individuals to determine the actual location of the potential security event. However, such a response may lead to a delay in a determination of the actual location of the security event because the response team is relying on general location information to locate the security event. For example, police may be dispatched to a location of an acoustic sensor that detected a gunshot, but the police may not know the actual location a gun that fired the gunshot. Security event detection system 103 may select one or more of the sensors included in the second layer of sensors 102 to determine a refined location of the detected security event. This may reduce the amount of time to launch an appropriate response and may prevent and/or reduce the amount of property damage, loss of human life, or prevent criminal activity.

The second layer of sensors 102 is comprised of m sensors. Examples of sensors included in the second layer of sensors 102 include, but are not limited to, cameras, image sensors, unmanned aerial vehicles equipped with detection sensors, directional sensors, RF sensors, infrared sensors, pressure sensors, etc. In some embodiments, a sensor included in the second layer of sensors 102 is stationary. For example, the sensor may be attached to a structure, such as a building, a light pole, a roof, etc. In some embodiments, a sensor included in the second layer of sensors 102 is mobile. For example, the sensor may be attached to a UAV, a car, a bicycle, a train, a subway car, a plane, a helicopter, etc.

Each of the sensors included in the second layer of sensors 102 may be registered with security event detection system 103. Security event detection system 103 may store in sensor information database 107 sensor information associated with each registered sensor. Sensor information may include detection range, detection resolution, detection type, detection angle, detection pitch, sensor error, the existence of any occlusions, availability information (in use, not in use), power information (plug in or battery powered), sensor location, etc. Security event detection system 103 may store sensor information database 107 that includes a plurality of entries, each entry associated with one of the registered sensors.

Using the initial location information included in the notification, security event detection system 103 may determine one or more sensors included in the second layer of sensors 102 that are capable of detecting a security event at, near, or within the initial location of the security event. Security event detection system 103 may scan through the entries included in sensor information database 107 to find one or more sensors that have a detection capability to detect the security event in an area at, near, or within the initial location of the security event. For example, a sensor included in the second layer of sensors may be physically located near the initial location of the detected security event, but unable to detect the security event due to an occlusion or lack of detection capability (e.g., the sensor is pointed in the wrong direction, the sensor cannot be adjusted to focus in a direction of the detected security event). Security event detection system 103 may exclude such a sensor from being selected. A sensor included in the second layer of sensors may be physically located near the initial location of the detected security event and has a detection capability (e.g., the sensor is pointed in the right direction without any occlusions) to detect the security event. Security event detection system 103 may include such a sensor in its selection of one or more sensors. Some sensors may be capable of detecting the security event, but are unavailable for one or more various reasons. For example, a sensor may be unavailable because the sensor is being used to detect another security event. Security event detection system 103 may exclude such as sensor from being selected.

Security event detection system 103 may select one or more of the sensors included in the second layer of sensors 102. Security event detection system 103 may select a primary sensor included in the second layer of sensors. In some embodiments, security event detection system 103 selects one or more secondary sensors included in the second layer of sensors. The primary and the one or more secondary sensors may be selected based on one or more factors. The one or more factors may include whether a sensor is currently availability, whether the location information outputted by at least one of the sensors included in the first layer of sensors is within a detection range of a sensor included in the second layer of sensors, detection resolution of the sensor, type of security event detected, and/or the existence of any occlusions. In some embodiments, security event detection system 103 may re-select sensors in the event the detected security event is not detected within a threshold period of time. In some embodiments, security event detection system 103 may select additional sensors after the initial selection to refine the initial location of the security event.

Security event detection system 103 may activate the selected sensors. Upon activation, the selected sensors may be configured to detect a security event. The selected sensors may be configured to detect a particular type of security event based on the indication provided by the at least one of the first layer of sensors 101. For example, the selected sensors may be configured to detect a UAV in the event the at least one of the first layer of sensors 101 detected a UAV flying near a protected airspace. The selected sensors may be used to triangulate a location of the detected security event. The selected sensors may detect the security event. For example, a camera may detect the security event within its field of view. An unmanned aerial vehicle may detect the security event using one of its sensors. Upon detecting the security event, a selected sensor may determine additional information associated with the detected security event. The additional information may include the nature of a detected security event (e.g., pipeline explosion, an unauthorized use of an unmanned aerial vehicle, a shooting). The additional information may include whether the detected security event is stationary or moving. The additional information may include object identification information associated with a security event, such as make and model of a vehicle, type of UAV, identification of one or more individuals associated with the detected security event. One of the selected sensors may be able to detect a location of an operator of a UAV associated with the detected security event and the additional information may include a location of an operator of the UAV associated with the detected security event. The additional information may include the speed of an object associated with the detected security event, a trajectory of an object associated with the detected security event, or a path of the object associated with the detected security event. The additional information may include refined location information associated with the detected security event. The refined location information may be a real-time location of the detected security event (e.g., coordinates of the detected security event). For example, the location of an object associated with the detected security event may be moving. The additional information may include an image of the security event.

Upon detecting the security event, at least one of the selected sensors may provide the additional information to security event detection system 103. Security event detection system 103 may be comprised of one or more processors 104. The one or more processors 104 may input the additional information to risk assessment module 105.

Risk assessment module 105 may be comprised of one or more machine learning models. The one or more machine learning models may be trained to output a value that indicates a threat level associated with the security event. For example, the one or more machine learning models may be configured to output a low security risk in the event the output of the one or more machine learning models is less than a first threshold value. The one or more machine learning models may be configured to output a medium security risk in the event the output of the one or more machine learning models is greater than or equal to a first threshold value and less than a second threshold value. The one or more machine learning models may be configured to output a high security risk in the event the output of the one or more machine learning models is greater than a second threshold value. Risk assessment module 105 may determine a threat level associated with a security event based on one or more features associated with the security event.

The one or more features may include a feature that indicates whether an individual associated with the security event is a previous offender or a trusted actor. For example, a camera may capture an image of an operator of an unmanned aerial vehicle. Risk assessment module 105 may determine whether the individual associated with the security event is a previous offender or a trusted actor by applying an image classifier to the captured image. The image classifier may output a value that indicates whether the individual associated with the security event is a previous offender. For example, the individual may be a person that frequently pilots a UAV near a stadium without permission. The image classifier may output a value that indicates whether the individual associated with the security event is a trusted actor. For example, the individual may be an authorized employee associated with a venue. Risk assessment module 105 may assign a first value for the feature in the event the individual associated with the security event is a previous offender or a trusted actor and a second value for the feature in the event the individual associated with the security event is not a previous offender or a trusted actor.

The one or more features may include a feature that indicates an amount of time until a violation. In some embodiments, the detected security event is an object approaching a protected airspace. For example, a UAV may be approaching the protected airspace around a stadium. Risk assessment module 105 may determine the amount of time before the detected security event is going to cross a boundary associated with a protected airspace. Risk assessment module 105 may assign a first value for the feature in the event the determined amount of time is less than a time threshold and a second value for the feature in the event the determined amount of time is greater than or equal to the time threshold.

The one or more features may include a feature that indicates a probabilistic trajectory of a future evolution given a plurality of past trajectories. In some embodiments, the detected security event is an object flying within a threshold distance of a protected airspace. For example, a UAV may be flying near a stadium during a stadium event. The UAV has an associated trajectory. Risk assessment module 105 may predict a future trajectory of the UAV based on the associated trajectory of the UAV. Risk assessment module 105 may compare the associated trajectory of the UAV to portions of a plurality of past UAV trajectories. Risk assessment module 105 may determine whether the associated trajectory of the UAV matches a portion of one or more other past trajectories. In the event risk assessment module 105 determines a match, risk assessment module 105 may use the one or more matching past trajectories to predict a future trajectory of the UAV. Risk assessment module 105 may determine whether the future trajectory of the UAV will cross a boundary line associated with a protected airspace. Risk assessment module 105 may assign the feature a first value in the event it determines that the future trajectory is going to cross a boundary line associated with a protected airspace and a second value in the event it determines that the future trajectory is not going to cross a boundary line associated with a protected airspace.

The one or more features may include a feature that indicates a time weighted and proximity weighted loitering value.

The one or more features may include a feature that indicates a measured value above an allowed limit. In some embodiments, the detected security event is an object flying above a legal height limit. In some embodiments, the detected security event is an object moving at a speed above a speed limit. Risk assessment module 105 may assign a value (e.g., 0 or 1) to a detected security event based on whether the object is associated with a measured value above an allowed limit.

The one or more features may include a feature that indicates a time of day associated with the detected security event. The time of day at which a security event is detected may be associated with a particular threat level. An administrator associated with a protected airspace may assign threat levels to different time periods during a day. For example, risk assessment module 105 may assign a detected security event near a bridge a first value if the security event was detected during rush hour and a second value if the security event was detected during non-rush hours.

The one or more features may include a feature that indicates a type of object detected associated with the security event. An image of a camera may detect a vehicle, such as a UAV, a car, a truck, a van, a plane, a bird, a balloon, etc. A type of vehicle, max speed associated with the vehicle, a size of the vehicle may be determined. Risk assessment module 105 may assign a corresponding value based on the type of object detected associated with the security event. For example, a white cargo van may be assigned a first value while a balloon may be assigned a second value. The value assigned to an object may indicate a threat level associated with the detected object.

The one or more features may include a feature that indicates a detection source. Risk assessment module 105 may assign a corresponding value to a security event based on the type of sensor that was used to detect the security event. Some sensors may be more accurate than other sensors.

The one or more features may include a feature that indicates a known source of potential security events. A government entity (e.g., FAA) may list one or more events that may cause a security event to be detected. For example, a movie company may be given clearance to fly a UAV over an airfield. Risk assessment module 105 may crosscheck with the known source of potential security events to determine if the detected security event is an actual security event. Risk assessment module 105 may assign the feature a first value in the event the detected security event is listed as a known source of potential security events and a second value in the event the detected security event is not listed as a known source of potential security events.

The one or more features may include a feature that indicates whether a detected security event is associated with a human operator. In some embodiments, the detected security event is an object flying near a protected airspace. The flight path of the object may vary depending upon whether the object is being operated by a human or is pre-programmed to fly a particular route. Risk assessment module 105 may assign the feature a first value in the event the detected security event is associated with a human operator and a second value in the event the detected security event is not associated with a human operator.

The one or more features may include a feature that indicates an intention associated with the detected security event. In some embodiments, the detected security event is an object flying near a protected airspace. A trajectory of the object may be inputted into a trajectory intention classifier. The trajectory intention classifier may be trained to output a value that indicates whether the trajectory of the object is malicious or benign. Risk assessment module 105 may assign the feature a first value in the event the trajectory intention classifier outputs a value that indicates the trajectory is malicious and a second value in the event the trajectory intention classifier outputs a value that indicates the trajectory is benign.

The one or more features may include a feature that indicates whether an objected associated with a detected security event has been modified to be disguised. In some embodiments, the detected security event is an object flying near a protected airspace. An image of the object may determine whether the object has been modified to be disguised in some way, shape, or manner. For example, a UAV may have been disguised such that it cannot be detected by a radar sensor, but an image sensor detected the disguised UAV. Risk assessment module 105 may assign the feature a first value in the event the object associated with the detected security event has been modified to be disguised and a second value in the event the object associated with the detected security event has not been modified to be disguised.

The one or more features may include a feature that indicates whether a detected security event is associated with a crowd of people. In some embodiments, the detected security event is an object flying near a protected airspace. For example, the object may be flying near a stadium hosting a sporting event. Risk assessment module 105 may assign the factor a first value in the event the detected security event is associated with a crowd of people and a second value in the event the detected security event is not associated with a crowd of people.

The assigned feature values may be combined to generate a feature vector. The generated feature vector may be applied to a machine learning model associated with risk assessment module 105. In response, the machine learning model may be configured to output a value that indicates a threat level associated with the detected security event.

Risk assessment module 105 may include one or more risk assessment rules. The one or more feature values are applied to one or more risk assessment rules. An output of a risk assessment rule may indicate whether a detected security event is a security risk. For example, in the event a feature that indicates an intention associated with the detected security event has a feature value that indicates a malicious intent, the risk assessment rule may output a value that indicates the detected security event is a high security risk. A UAV may be flying directly towards a protected airspace and the feature value indicates that the UAV intends to crash into a building included within the protected airspace. The risk assessment rule may output a value that causes a risk assessment of the detected security event to be a high security risk.

Risk assessment module 105 may provide its determined threat level to response module 106. Response module 106 may perform or cause to perform a response based on the determined threat level. For example, a first response may be performed or caused to be performed in the event the determined threat is below a first threshold level. A second response may be performed or caused to be performed in the event the determined threat is greater than or equal to a first threshold level and less than a second threshold level. A third response may be performed or caused to be performed in the event the determined threat is greater than or equal to a second threshold level. Examples of responses include logging the security event, activating an interdiction system, notifying the authorities, transmitting a jamming signal, notifying an administrative team, etc.

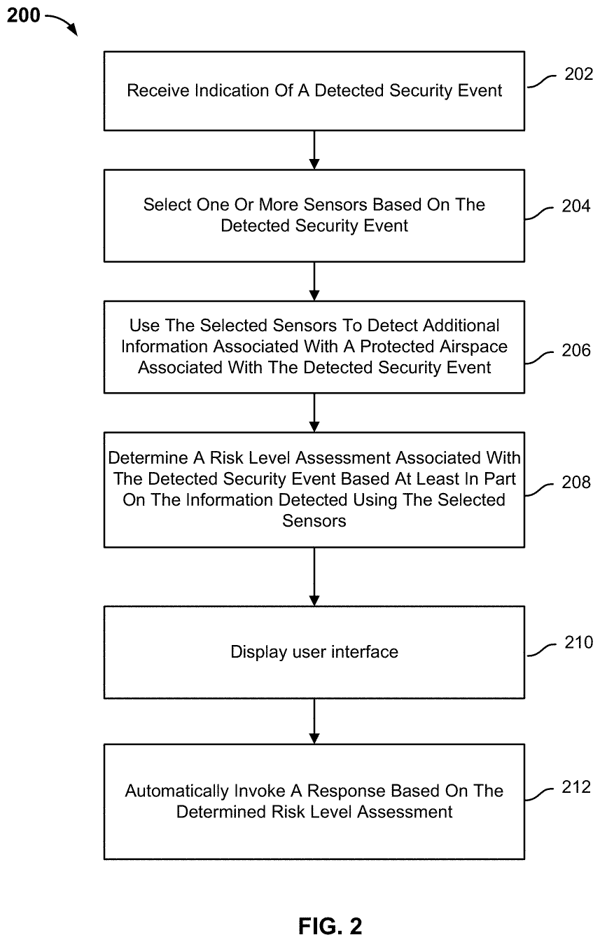

FIG. 2 is a flow chart illustrating an embodiment of a process for responding to a detected security event. In the example shown, process 200 may be implemented by a security event detection system, such as security event detection system 103.

At 202, an indication of a detected security event is received. The security event detection system may be comprised of a first layer of sensors and a second layer of sensors. The first layer of sensors is comprised of a first plurality of sensors. At least one of the sensors included in the first layer of sensors may provide the indication of the detected security event to the security event detection system.

The sensor data may be associated with a region (e.g., airspace, geographical region, etc.) being monitored. Examples of the sensor data include 2D/3D radar signal data, UAV location tracking data, UAV operator location tracking data, LIDAR data, image/video data, data about detected communication between UAV and operator, and any other signal or information associated with an area being monitored. The sensor data may be received from multiple sources (e.g., 2D/3D radar, RF antenna, camera, LIDAR sensor, etc.). Conventional radar is used to quickly detect and track points in space.

At 204, one or more sensors are selected based on the detected security event. Upon detecting a potential security event, a sensor included in the first layer of sensors may output a value indicating an initial location of the potential security event. The output from the first layer of sensors may not be precise enough to determine the actual location of the potential security event. One or more subsequent scans may be performed using one or more of the sensors included in the first layer of sensors to refine the location of the security event, however, the one or more subsequent scans may be too time-consuming to determine the actual location of the security event or unable to determine the actual location of the security event.

The location data outputted by at least one of the sensors included in the first layer of sensors may be provided to a security event detection system, which may use the location data to select one or more sensors included in a second layer of sensors. The second layer of sensors is comprised of a second plurality of sensors.

Each of the sensors included in the second layer of sensors may be registered with the security event detection system. The security event detection system may store sensor information associated with each registered sensor. Sensor information may include detection range, detection resolution, detection type, detection angle, detection pitch, the existence of any occlusions, availability information (in use, not in use), power information (plug in or battery powered), sensor location, etc. The security event detection system may store a sensor information database that includes a plurality of entries, each entry associated with one of the registered sensors. The security event detection system may scan the plurality of entries to identify one or more sensors that have a capability to detect the potential security event based on the location information provided by the at least one sensor included in the first layer of sensors. A sensor may have a capability to detect the security event in the event the sensor information associated with the sensor indicates that the security event is within a detection range of the sensor, within a detection angle/pitch of the sensor, and/or no occlusions prevent the sensor from detecting the security event.

The security event detection system may use the location information outputted by at least one of the sensors included in the first layer of sensors to select a primary sensor included in the second layer of sensors. In some embodiments, the security event detection system selects one or more secondary sensors included in the second layer of sensors. The primary and the one or more secondary sensors may be selected based on one or more factors. The one or more factors may include whether a sensor is currently available, whether the location information outputted by at least one of the sensors included in the first layer of sensors is within a detection range of a sensor included in the second layer of sensors, detection resolution of the sensor, is capable of moving with a detection area associated with a detection sensor included in the first layer of sensors, is capable of being adjusted to focus in the detection area associated with the detection sensor included in the first layer of sensors, within a detection angle/pitch of the sensor, and/or the existence of any occlusions. A sensor may be near the detected security event (e.g., within 50 feet), but unable to detect the security event because the sensor is pointed in the wrong direction. Such a sensor would not be selected to detect the security event. A sensor may be far from the detected security event (e.g., 2 miles), but able to detect the security event because the initial location of the security event is within a detection zone (e.g., within a detection range and within a detection angle/pitch of the sensor) associated with the sensor. Such a sensor may be selected as a primary sensor or a secondary sensor.

At 206, the selected sensors are used to detect additional information associated with a protected airspace associated with the detected security event. The security event detection system may activate the selected sensors. Upon activation, the one or more selected sensors may be used to detect a refined location of the detected security event. For example, an image sensor may detect the security event within its field of view. At least one of the selected sensors may determine additional information associated with the detected security event. For example, the additional information may include the nature of a detected security event (e.g., pipeline explosion, an unauthorized use of an unmanned aerial vehicle, a shooting). The additional information may include whether the detected security event is stationary or moving. The additional information may include object identification information, such as make and model of a vehicle, type of UAV, identification of one or more individuals associated with the detected security event, purpose of object (e.g., mapping, photometry, etc.). One of the selected sensors may be able to detect a location of an operator of a UAV and the additional information may include a location of an operator associated with an UAV. The additional information may include the speed of an object, a trajectory of an object, a direction in which the object is looking (e.g., yaw angle), or a path of the object. The additional information may include refined location information associated with the detected security event. The refined location information may be a real-time location of the detected security event. For example, one of the sensors may track the location of an object associated with the detected security event as the object is moving.

Additional information is obtained from the selected sensors. The selected sensors may include range finders and cameras. A radiofrequency (RF) range finder may be used to detect and geolocate UAVs. The RF range finder may be configured with an RF receiver and monitors UAVs by detecting the radio communications links to the UAVs. By monitoring radio communications links, the RF range finder may be able to perform UAV classification based on RF information received related to a UAV's vendor, communication protocol, RF frequency, and other characteristics. The RF range finder may also be configured to include a directional antenna to determine the angle of RF signals. Two RF range finders may be used to triangulate the location of the operator of the UAV by using basic geometric principles. For example, triangulation can be performed by placing two RF range finders in separate locations and determining a point of convergence of RF signals sent from the UAV to the operator of the UAV. Cameras are also used to detect and track UAVs. A camera with pan/tilt/zoom capability may be used configured to detect and track moving objects within a frame. Any visual information (e.g., shape, color, movement characteristics, etc.) may also be used in the threat level analysis described below. Altitude information can be determined from the sensors described above (e.g., visual cues from camera data, three-dimensional radar, and geolocation information from RF range finders). The trajectory of the UAV may also be monitored and predicted. Past flight trajectory may be determined by collecting and plotting past geolocation data (e.g., from radar, cameras, and RF range finders). Predicted trajectory can be obtained through various algorithms (e.g., Kalman filtering). For example, a basic path prediction algorithm comprises measuring speed from recent flight history data and extrapolating future positions by multiplying speed and time.

At 208, a risk level assessment associated with the detected security event is determined based at least in part on the information detected using the selected sensors. The security event detection system may include a machine learning model. A feature vector may be applied to the machine learning model. The feature vector may be comprised of a plurality of elements. Each element may correspond to a feature associated with a security event. A feature value may be based directly or indirectly on the additional information obtained by the one or more selected sensors. In response to the feature vector being applied to the machine learning model, the machine learning model may be configured to output a value that indicates a threat level associated with the detected security event (e.g., a threat score).

A risk assessment of a low security risk may be outputted in the event the output of the one or more machine learning models (e.g., threat score) is less than a first threshold value. A risk assessment of a medium security risk may be outputted in the event the output of the one or more machine learning models (e.g., threat score) is greater than or equal to a first threshold value and less than a second threshold value. A risk assessment of a low security risk may be outputted in the event the output of the one or more machine learning models (e.g., threat score) is greater than a second threshold value.

When a threat level score is determined, a higher score may correspond to a greater threat level than a lower score. Sensor data from steps 202, 206 may be analyzed to determine a threat level associated with a detected UAV in a monitored airspace. For example, a piece of information used in assessing threat level is the UAV's proximity to a specified airspace being monitored. The UAV being close to a sensitive/restricted airspace may contribute to a higher threat level assessment. In addition, the trajectory of the UAV may be considered. Certain trajectories (e.g., a trajectory directly into a sensitive area) might contribute to a higher threat level assessment. Threat level assessment is multifactorial. For example, both location and trajectory are considered. If a UAV is close to a sensitive area but has a trajectory going away from the sensitive area, then a low threat level assessment might result even though the UAV is close to the sensitive area. Time domain and/or flight history of the UAV may also be considered. For example, if a time and/or flight history of a UAV showing it to fly in paths close to but not entering a sensitive area might contribute to a lower threat level assessment. Characteristics of UAVs are considered when assessing threat level. Examples of characteristics that can be considered include UAV shape, UAV vendor, UAV communications protocol, UAV speed/altitude/location/trajectory, operator location, and other characteristics (e.g., those measured in steps 202, 206). In various embodiments, artificial intelligence and machine learning methods may be used to identify and track UAVs and assess threat levels. Threat level can be classified in numerical terms. For example, a threat level score from zero to five (e.g., higher score corresponds to greater threat risk) generated from a probabilistic prediction of threat level incorporating the data received from sensors in steps 202, 206 can be assigned to each UAV.

At 210, a user interface is displayed. For example, the user interface provides a visual indication of current and past locations of detected security events, such as UAVs as well their trajectories and corresponding threat level classification ranking (e.g., determined using a machine learning trained model). The user interface may also provide a visual indication of a current, past and/or movement trajectory locations of an operator of a detected UAV (e.g., by detecting and locating source of RF control signal sent by the UAV operator). A threat level score is automatically represented to the user through the user interface. The user interface displays a color trajectory of the UAV along with the threat level score. In addition, the user interface includes a component that allows a human to override threat level assessments that were determined automatically. For example, threat level assessments can be downgraded by a user using the interface if the user manually determines an identified object is not a suspicious UAV or is not a UAV (e.g., is a bird). Similarly, a user can upgrade a threat level assessment. User responses to threat level assessments can be stored by the user interface and used to train artificial intelligence/machine learning methods with respect to future threat level assessments. For example, when a user downgrades threat level assessments associated with certain trajectories, a system that automatically assesses threat level can consider the downgrades when making future threat level assessments. Thus, threat level scores are informed by input from users combined with artificial intelligence assessments and any particular algorithmic rules that are incorporated (e.g., automatic threat level assessments if certain location and trajectory characteristics associated with a UAV are detected).

At 212, a response based on the determined risk level assessment is automatically invoked. The security event detection system may be configured to automatically invoke a response for the detected security event based on an output of the machine learning model. The detected security event may be classified as a “low security risk,” “medium security risk,” or a “high security risk” based on the output of the machine learning model. The security event detection system may automatically invoke a response that corresponds to the determined security risk. For example, the security event detection system may perform or cause to perform a first type of response in the event the detected security event is classified as a “low security risk,” a second type of response in the event the detected security event is classified as a “medium security risk,” and a third type of response in the event the detected security event is classified as a “high security risk.”

In various embodiments, for every threat level associated with a detected aerial object/UAV, there is a set of preconfigured actions associated with that threat level. Automatic actions associated with threat levels may be triggered when certain threat levels are assessed. Examples of actions that can be initiated based on threat level assessments include contacting law enforcement, generating a notification/message to send to specified people or organizations, triggering an alarm, sending an interceptor UAV to capture/interdict the detected UAV considered a threat, sending personnel to a where the operator of the UAV is located, initiating a lockdown of a sensitive/restricted area, and starting other procedures. In some embodiments, a response team is notified with the refined location of the detected security event. In some embodiments, a notification is provided to an administrative team associated with a protected airspace.

An attempt to disable the UAV may be made when a specified threat level is reached. One approach to disable a UAV is to jam, block, or interfere with the communications system of the UAV so that the UAV is unable to communicate with a remote operator. This may prevent the remote operator from controlling the UAV to arrive at its intended destination. In-flight, the UAV may be in communication with one or more remote computing devices associated with a remote operator. In some instances, in the event the UAV loses communication with the one or more remote computing devices associated with the remote operator, the UAV may be configured to implement a communication failure procedure and return to a specific location. For example, the UAV may be configured to return to a home location, e.g., a location specified by a user of the UAV. While this may prevent the UAV from performing its intended task, the UAV may still be used at a later time to carry out its intended task. A UAV may be disabled and/or captured by another UAV. A defending UAV may include a detector to determine that a flying object is a UAV, a jamming system to disable a target UAV, and an interdiction system to automatically capture the target UAV when the target UAV is disabled.

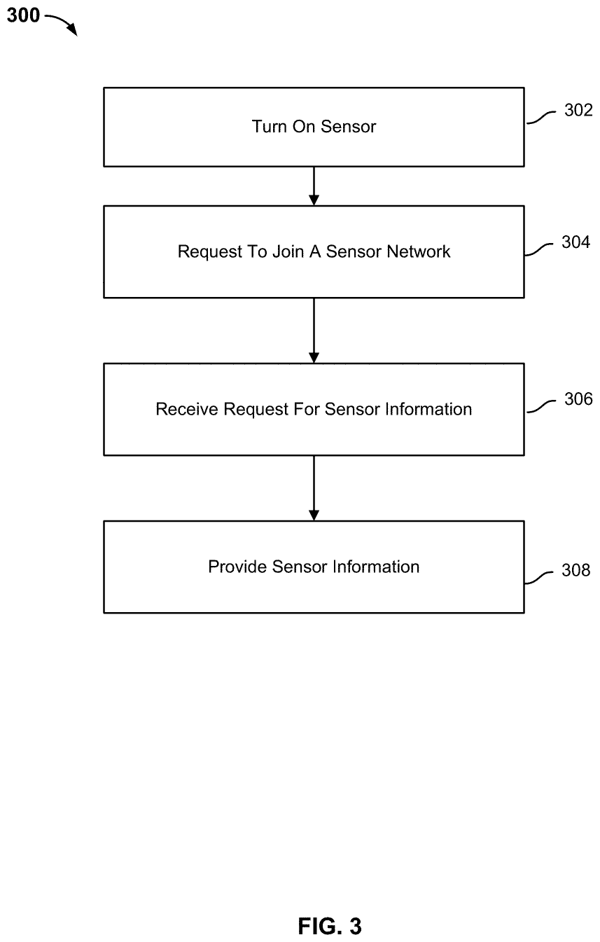

FIG. 3 is a flow chart illustrating an embodiment of a process for joining a network of sensors. In the example shown, process 300 may be implemented by one of the sensors included in the first layer of sensors 101. Process 300 may also be implemented by one of the sensors included in the second layer of sensors 102.

At 302, a sensor is turned on. In some embodiments, the sensor is a stand-alone device. In other embodiments, the sensor is coupled to a computing device (e.g., laptop, tablet, smartphone, etc.).

At 304, a request to join a sensor network is sent to a security event detection system. The sensor or the computing device to which the sensor is coupled may be connected to a network. A user of the sensor or computing device may send to the security event detection system a request to join a sensor network. The sensor network may be comprised of a first layer of sensors and a second layer of sensors. The sensor may be added to either the first layer of sensors or the second layer of sensors based on a sensing capability associated with the sensor.

At 306, a request for sensor information associated with the sensor is received. The security event detection system may request sensor information, such as detection range, detection resolution, detection type, detection angle, detection pitch, the existence of any occlusions, availability information (in use, not in use), power information (plug in or battery powered), sensor location, etc.

At 308, the requested sensor information is provided. In response to receiving the sensor information, the security event detection system may store the received sensor information and assign the sensor to a first layer of sensors or a second layer of sensors.

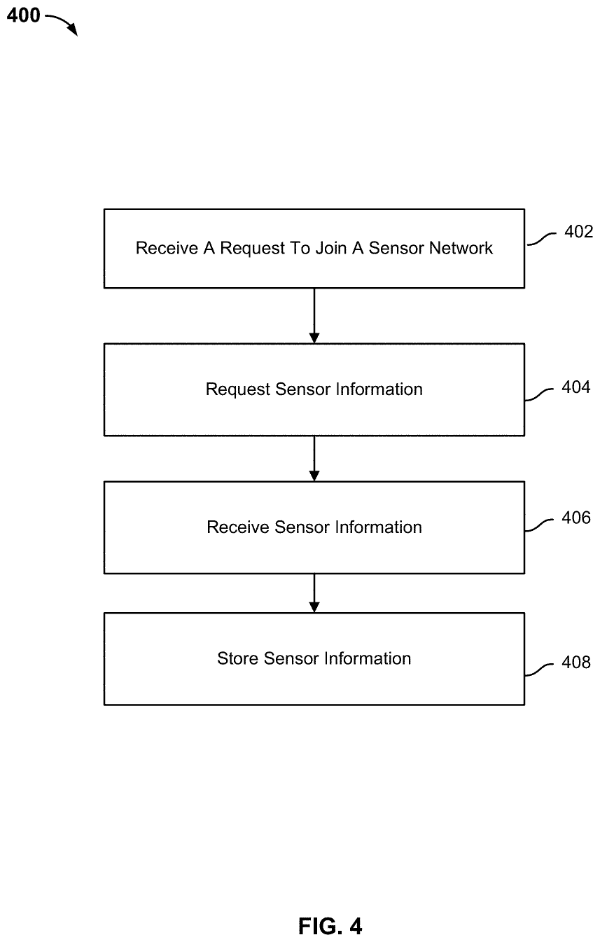

FIG. 4 is a flow chart illustrating an embodiment of a process for generating a database of sensor information. In the example shown, process 400 may be implemented by a security event detection system, such as security event detection system 103.

At 402, a request to join a sensor network is received. The request may be received from a sensor or a computing device coupled to the sensor.

At 404, a request for sensor information is sent. The request may be sent to the sensor or the computing device coupled to the sensor. The request may be for sensor information, such as detection range, detection resolution, detection type, detection angle, detection pitch, the existence of any occlusions, availability information (in use, not in use), power information (plug in or battery powered), sensor location, etc.

At 406, sensor information is received. The sensor information may include information, such as detection range, detection resolution, detection type, detection angle, detection pitch, the existence of any occlusions, availability information (in use, not in use), power information (plug in or battery powered), sensor location, etc.

At 408, sensor information is stored. The sensor information may be stored in a database. The database may be comprised of a plurality of entries, each entry storing sensor information associated with a sensor. The database may be used by the security event detection system to determine one or more available sensors to detect a security event.

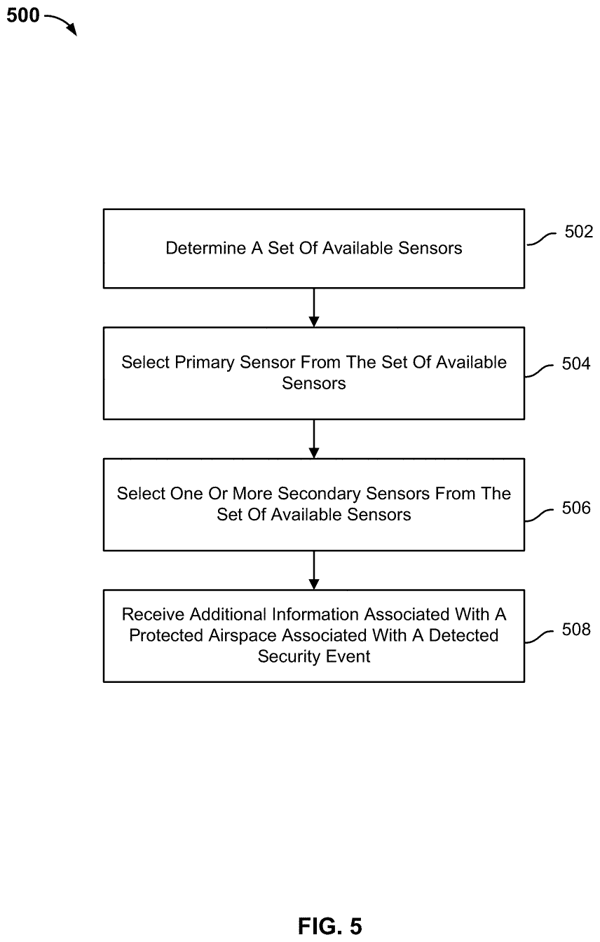

FIG. 5 is a flow chart illustrating an embodiment of a process for selecting one or more sensors. In the example shown, process 500 may be implemented by a security event detection system, such as security event detection system 103. In some embodiments, process 500 is implemented to perform some or all of step 204 of process 200.

At 502, a set of available sensors is determined. A security event detection system may store in a database a list of registered sensors. Some of the registered sensors may be associated with a first layer of sensors. Some of the registered sensors may be associated with a second layer of sensors. The security event detection system may determine from the registered sensors associated with the second layer of sensors a set of available sensors. A sensor may be unavailable in the event the sensor has already been selected to assist in detecting a different security event. The security event detection system may filter the unavailable sensors from the list of registered sensors to determine the set of available sensors.

At 504, a primary sensor is selected from the set of available sensors. A security event detection system may receive initial location information associated with a security event. The primary sensor may be selected based on one or more factors. For example, the primary sensor may be selected based on whether the location information outputted by at least one of the sensors included in the first layer of sensors is within a detection range of a sensor included in the second layer of sensors, detection resolution of the sensor, and/or the existence of any occlusions.

At 506, one or more secondary sensors are selected from the set of available sensors. One or more secondary sensors may be selected to triangulate the location of a detected security event. The one or more secondary sensors may be selected based on whether the location information outputted by at least one of the sensors included in the first layer of sensors is within a detection range of a sensor included in the second layer of sensors, detection resolution of the sensor, and/or the existence of any occlusions.

At 508, additional information associated with a protected airspace associated with a detected security event is received from the selected sensors. At least one of the selected sensors may determine additional information associated with the detected security event. For example, the additional information may include the nature of a detected security event (e.g., pipeline explosion, an unauthorized use of an unmanned aerial vehicle, a shooting). The additional information may include whether the detected security event is stationary or moving. The additional information may include object identification information, such as make and model of a vehicle, type of UAV, identification of one or more individuals associated with the detected security event. One of the selected sensors may be able to detect a location of an operator of a UAV and the additional information may include a location of an operator associated with an UAV. The additional information may include the speed of an object, a trajectory of an object, or a path of the object. The additional information may include refined location information associated with the detected security event. The refined location information may be a real-time location of the detected security event.

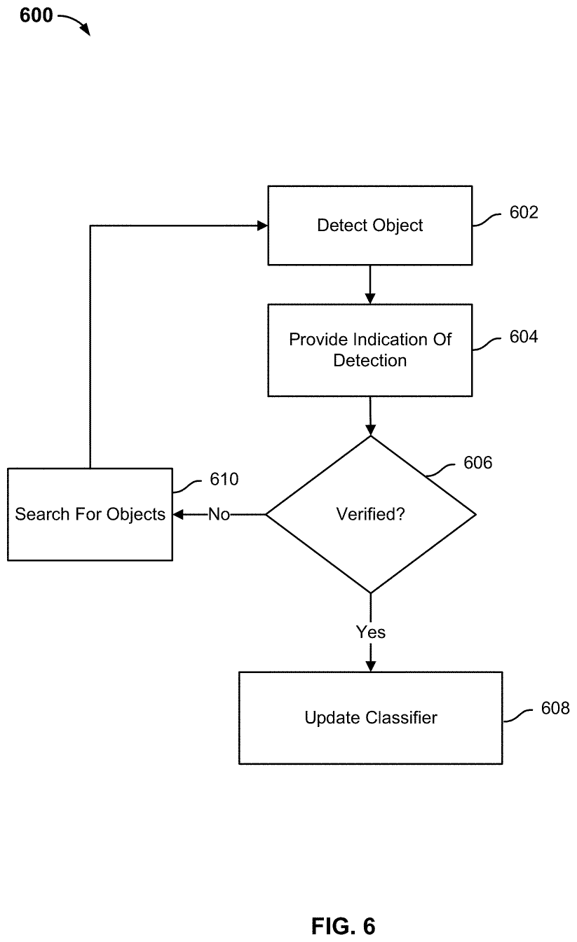

FIG. 6 is a flow chart illustrating an embodiment of a process for detecting a security event. In the example shown, process 600 may be implemented by a sensor, such as one of the sensors included in the second layer of sensors 102.

At 602, an object is detected. A sensor may detect an object. In some embodiments, the sensor may be an image sensor included in a camera. The object may be detected within a field of view of the image sensor. The image sensor may zoom in on an area of the field of view in which the object was detected.

At 604, an indication of a detection is provided. The indication may be provided to a security event detection system. The indication may include a zoomed-in image of the detected object. The indication may include a classification of the detected object.

At 606, an indication of whether the classification of the detected object is verified is received. A user associated with the security event detection system may indicate whether the detected object classification is correct. In the event the object classification is verified, process 600 proceeds to 608. In the event the object classification is not verified, process 600 proceeds to 610.

At 608, a classifier trained to detect objects is updated. The classifier may be updated such that it more accurately detects objects of a type associated with the detected object. At 610, the sensor may continue the search for one or more objects.

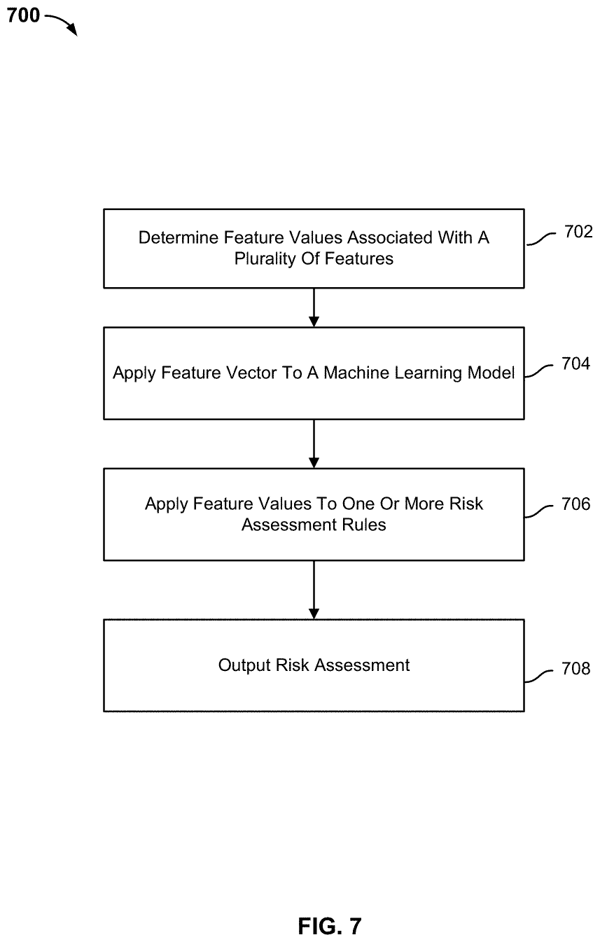

FIG. 7 is a flow chart illustrating an embodiment of a process for determining a risk assessment associated with a detected security event. In the example shown, process 700 may be implemented by a security event detection system, such as security event detection system 103.

At 702, feature values associated with a plurality of features are determined. A security event detection system may determine a risk assessment of a security event based on a plurality of features. The corresponding feature values associated with the plurality of features may be used to determine whether a security event poses a security risk.

The plurality of features may include a feature that indicates whether an individual associated with the security event is a previous offender or a trusted actor. For example, a camera may capture an image of an operator of an unmanned aerial vehicle. It may determine whether the individual associated with the security event is a previous offender or a trusted actor by applying an image classifier to the captured image. The image classifier may output a value that indicates whether the individual associated with the security event is a previous offender. For example, the individual may be a person that frequently pilots a UAV near a stadium without permission. The image classifier may output a value that indicates whether the individual associated with the security event is a trusted actor. For example, the individual may be an authorized employee associated with a venue. A first value may be assigned for the feature in the event the individual associated with the security event is a previous offender or a trusted actor and a second value may be assigned for the feature in the event the individual associated with the security event is not a previous offender or a trusted actor.

The plurality of features may include a feature that indicates an amount of time until a violation. In some embodiments, the detected security event is an object approaching a protected airspace. For example, a UAV may be approaching the protected airspace around a stadium. The amount of time before the detected security event is going to cross a boundary associated with a protected airspace may be determined. A first value may be assigned for the feature in the event the determined amount of time is less than a time threshold and a second value may be assigned for the feature in the event the determined amount of time is greater than or equal to the time threshold.

The plurality of features may include a probabilistic trajectory of a future evolution given a plurality of past trajectories. In some embodiments, the detected security event is an object flying within a threshold distance of a protected airspace. For example, a UAV may be flying near a stadium during a stadium event. The UAV has an associated trajectory. A future trajectory of the UAV may be predicted based on the associated trajectory of the UAV.

The risk assessment module may compare the associated trajectory of the UAV to portions of a plurality of past UAV trajectories. It may determine whether the associated trajectory of the UAV matches a portion of one or more other past trajectories. In the event the associated trajectory matches a portion of one or more other past trajectories, the one or more matching past trajectories may be used to predict a future trajectory of the UAV. The risk assessment module may determine whether the future trajectory of the UAV will cross a boundary line associated with a protected airspace. The feature may be assigned a first value in the event it is determined that the future trajectory is going to cross a boundary line associated with a protected airspace and may be assigned a second value in the event it is determined that the future trajectory is not going to cross a boundary line associated with a protected airspace.

The plurality of features may include a feature that indicates a time weighted and proximity weighted loitering value.

The plurality of features may include a feature that indicates a measured value above an allowed limit. In some embodiments, the detected security event is an object flying above a legal height limit. In some embodiments, the detected security event is an object moving at a speed above a speed limit. A value (e.g., 0 or 1) may be assigned to the feature based on whether the object associated with a detected security event is associated with a measured value above an allowed limit.

The plurality of features may include a feature that indicates a time of day associated with the detected security event. The time of day at which a security event is detected may be associated with a particular threat level. An administrator associated with a protected airspace may assign threat levels to different time periods during a day. The feature may be assigned a first value if the security event was detected during rush hour and may be assigned a second value if the security event was detected during non-rush hours.

The plurality of features may include feature a type of object detected associated with the security event. An image of a camera may detect a vehicle, such as a UAV, a car, a truck, a van, a plane, a bird, a balloon, etc. A type of vehicle, max speed associated with the vehicle, a size of the vehicle may be determined. A corresponding value may be assigned to the feature based on the type of object detected associated with the security event. For example, a white cargo van may be assigned a first value while a balloon may be assigned a second value. The value assigned to the feature may indicate a threat level associated with the detected object.

The plurality of features may include a feature that indicates a detection source. A corresponding value may be assigned to the feature based on the type of sensor that was used to detect the security event. Some sensors may be more accurate than other sensors.

The plurality of features may include a feature that indicates a known source of potential security events. A government entity (e.g., FAA) may list one or more events that may cause a security event to be detected. For example, a movie company may be given clearance to fly a UAV over an airfield. A risk assessment module may crosscheck with the known source of potential security events to determine if the detected security event is an actual security event. The feature may be assigned a first value in the event the detected security event is listed as a known source of potential security events and a second value in the event the detected security event is not listed as a known source of potential security events.

The plurality of features may include a feature that indicates whether a detected security event is associated with a human operator. In some embodiments, the detected security event is an object flying near a protected airspace. The flight path of the object may vary depending upon whether the object is being operated by a human or is pre-programmed to fly a particular route. The feature may be assigned a first value in the event the detected security event is associated with a human operator and a second value in the event the detected security event is not associated with a human operator.

The plurality of features may include a feature that indicates an intention associated with the detected security event. In some embodiments, the detected security event is an object flying near a protected airspace. A trajectory of the object may be inputted into a trajectory intention classifier. The trajectory intention classifier may be trained to output a value that indicates whether the trajectory of the object is malicious or benign. The feature may be assigned a first value in the event the trajectory intention classifier outputs a value that indicates the trajectory is malicious and the feature may be assigned a second value in the event the trajectory intention classifier outputs a value that indicates the trajectory is benign.

The plurality of features may include a feature that indicates whether an objected associated with a detected security event has been modified to be disguised. In some embodiments, the detected security event is an object flying near a protected airspace. An image of the object may determine whether the object has been modified to be disguised in some way, shape, or manner. For example, a UAV may have been disguised such that it cannot be detected by a radar sensor, but an image sensor detected the disguised UAV. The feature may be assigned a first value in the event the object has been modified to be disguised and the feature may be assigned a second value in the event the detected security event has not been modified to be disguised.

The plurality of features may include a feature that indicates whether a detected security event is associated with a crowd of people. In some embodiments, the detected security event is an object flying near a protected airspace. For example, the object may be flying near a stadium hosting a sporting event. The feature may be assigned a first value in the event the detected security event is associated with a crowd of people and the feature may be assigned a second value in the event the detected security event is not associated with a crowd of people.

At 704, a feature vector is applied to a machine learning model. The feature vector is comprised of a plurality of features. In some embodiments, each of the features has a corresponding weight. Some of the features may be weighted more than some of the other features. The feature vector may be comprised of some or all of the features determined based on the additional information.

The machine learning model may be a supervised machine learning model, an unsupervised machine learning model, or a reinforcement machine learning model. Examples of supervised machine learning models include, but are not limited to, support vector machines, linear regression, logistic regression, naïve Bayes, linear discriminant analysis, decision trees, k-nearest neighbor algorithm, neural networks, and similarity learning. Examples of unsupervised machine learning models include, but are not limited to, clustering (e.g., k-means), anomaly detection, neural networks, deep learning. Examples of reinforcement machine learning models include, but are not limited to, Q-Learning, Temporal Difference, and Deep Adversarial Networks.

At 706, the one or more feature values are applied to one or more risk assessment rules. An output of a risk assessment rule may indicate whether a detected security event is a security risk. For example, in the event a feature that indicates an intention associated with the detected security event has a feature value that indicates a malicious intent, the risk assessment rule may output a value that indicates the detected security event is a high security risk. A UAV may be flying directly towards a protected airspace and the feature value indicates that the UAV intends to crash into a building included within the protected airspace. The risk assessment rule may output a value that causes a risk assessment of the detected security event to be a high security risk.

At 708, a risk assessment is outputted. A risk assessment may be based on an output of a machine learning model. The risk assessment may be based on an output of one or more rules. The risk assessment may be based on a combination of the machine learning model output and the output of one or more rules. A risk assessment of a low security risk may be outputted in the event the output of the one or more machine learning models is less than a first threshold value. A risk assessment of a medium security risk may be outputted in the event the output of the one or more machine learning models is greater than or equal to a first threshold value and less than a second threshold value. A risk assessment of a low security risk may be outputted in the event the output of the one or more machine learning models is greater than a second threshold value. In some embodiments, an output of a rule may cause a risk assessment determination to automatically classify a detected security event as a high security risk. In some embodiments, an output of a rule may cause a risk assessment determination to automatically classify a detected security event as a medium security risk. In some embodiments, an output of a rule may cause a risk assessment determination to automatically classify a detected security event as a low security risk.

In some embodiments, step 704 is optional. In some embodiments, step 706 is optional. In some embodiments, step 704 and 706 are required.

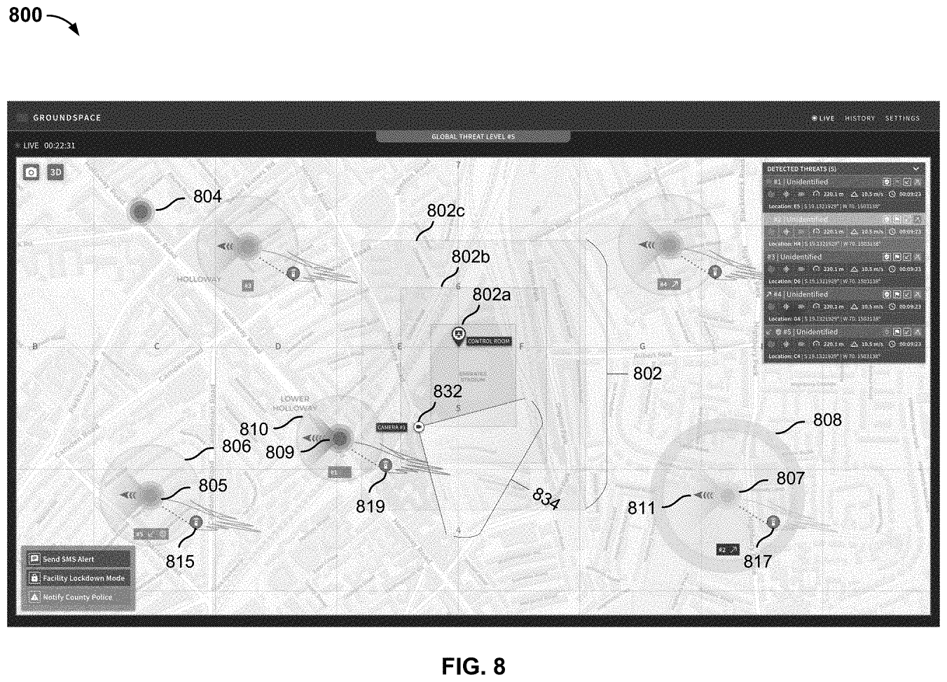

FIG. 8 is an example of a user interface in accordance with some embodiments. In the example shown, user interface 800 may be generated by a user interface, such as user interface 108.

In the example shown, a plurality of security events associated with a protected airspace 802 have been detected. A protected airspace may be associated with one or more layers. In the example shown, protected airspace 802 is associated with a first layer 802a, a second layer 802b, and a third layer 803a. A response to a detected security event may differ based on whether the detected security event is located in the first layer, second layer, or third layer. User interface 800 depicts an example of a sensor included in a sensor layer. Camera 832 is shown within protected airspace 802 with its corresponding coverage area 834.

Each of the detected security events are represented by a circle on the user interface 800. In the example shown, each of the detected security events is associated with a color. The color may indicate an associated security risk level. For example, detected security event 804 is represented by a gray circle. The color gray may indicate that the detected security event is benign. Detected security event 805 is represented by a green circle. The color green may indicate that the detected security event is a low security risk. Detected security event 807 is represented by a yellow circle. The color yellow may indicate that the detected security event is a medium security risk. Detected security event 809 is represented by a red circle. The color red may indicate that the detected security event is a high security risk. Detected security events may have one or more other colors not depicted in FIG. 8 and be associated with one or more other security risk levels.

A detected security event may be the detection of a UAV flying near a protected airspace 802. A detected security event may be flying at a corresponding altitude. The corresponding altitude may be represented by an altitude circle. For example, detected security event 805 is associated with altitude circle 806, detected security event 807 is associated with altitude circle 808, and detected security event 809 is associated with altitude circle 810. A radius of an altitude circle may indicate a flying height associated with detected security event.

User interface 800 may track a location associated with a detected security event over time. In the example shown, the trajectory paths of detected security events 805, 807, 809 are shown. User interface 800 may also display a predicted trajectory path associated with a detected security event. For example, predicted trajectory path 811 is displayed and associated with detected security event 807. The initial location of a detected security event may be displayed. The initial locations 815, 817, 819 are associated with detected security events 805, 807, 809, respectively.

In response to a user command, user interface 800 may increase a risk assessment associated with a detected security event, decrease a risk assessment associated with a detected security event, mark a detected security event as friendly, or share a threat of the detected security event with one or more entities.

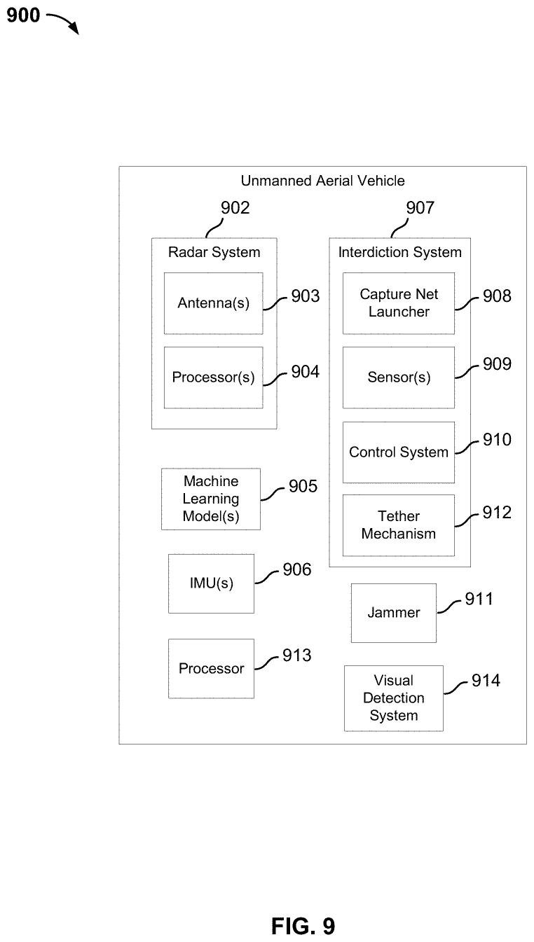

FIG. 9 is a block diagram illustrating an embodiment of an unmanned aerial vehicle. Unmanned aerial vehicle 900 is an example of a system that may be deployed to respond to a detected security event, such as a response included in step 210 of process 200. Unmanned aerial vehicle 900 is comprised of a radar system 902, one or more machine learning models 905, one or more inertial measurement units 906, an interdiction system 907, a jammer 911, a processor 913, and a visual detection system 914.

Radar system 902 is comprised of one or more antennas 103 and one or more processors 904. The one or more antennas 903 may be a phased array, a parabolic reflector, a slotted waveguide, or any other type of antenna design used for radar. The one or more processors 904 are configured to excite a transmission signal for the one or more antennas 903. The transmission signal has a frequency f₀. Depending on the antenna design, the transmission signal may have a frequency between 3 MHz to 110 GHz. In response to the excitation signal, the one or more antennas 903 are configured to transmit the signal. The transmission signal may propagate through space and reflect off one or more objects. The reflection signal may be received by the one or more antennas 903. In some embodiments, the reflection signal is received by a subset of the one or more antennas 903. In other embodiments, the reflection signal is received by all of the one or more antennas 903. The strength (amplitude) of the received signal depends on a plurality of various factors, such as a distance between the one or more antennas 903 and the reflecting object, the medium in which the signal is transmitted, the environment, the material of the reflecting object, etc. In other embodiments, no reflection signal is received by the one or more antennas 903. This indicates that an object was not detected.

The one or more processors 904 are configured to receive the reflection signal from the one or more antennas 903. The one or more processors 904 are configured to determine a velocity of the detected object based on the transmission signal and the reflection signal. The velocity may be determined by computing the Doppler shift. A detected object may have one or more associated velocities. An object without any moving parts, such as a balloon, may be associated with a single velocity. An object with moving parts, such as a car, helicopter, UAV, plane, etc., may be associated with more than one velocity. The main body of the object may have an associated velocity. The moving parts of the object may each have an associated velocity. For example, a UAV is comprised of a body portion and a plurality of rotors. The body portion of the UAV may be associated with a first velocity. Each of the rotors may be associated with corresponding velocities.

In some embodiments, the one or more antennas 903 is a phased antenna array. In the event the one or more antennas 903 detect an object, a beam associated with the phase antenna array may be directed towards the object. To change the directionality of the antenna array when transmitting, a beam former (e.g., the one or more processors 904) may control the phase and relative amplitude of the signal at each transmitting antenna of the antenna array, in order to create a pattern of constructive and destructive interference in the wave front.

Radar system 902 is coupled to the one or more inertial measurement units 906. The one or more inertial measurement units 906 are configured to calculate attitude, angular rates, linear velocity, and/or a position relative to a global reference frame. The one or more processors 904 may use the measurements from the one or more IMUs 109 to determine an EGO motion of the UAV 900. The one or more processors 904 may also use one or more extended Kalman filters to smooth the measurements from the one or more inertial measurement units 906. One or more computer vision-based algorithms (e.g., optical flow) may be used to determine the EGO motion of UAV 900. The one or more processors 904 may be configured to remove the EGO motion data of UAV 900 from the reflection signal data to determine one or more velocities associated with a detected object. From UAV 900's perspective, every detected item appears to be moving when UAV 900 is flying. Removing the EGO motion data from the velocity determination allows radar system 902 to determine which detected objects are static and/or which detected objects are moving. The one or more determined velocities may be used to determine a micro-Doppler signature of an object.

The one or more processors 904 may generate a velocity profile from the reflected signal to determine a micro-Doppler signature associated with the detected object. The velocity profile compares a velocity of the reflection signal(s) with an amplitude (strength) of the reflection signal(s). The velocity axis of the velocity profile is comprised of a plurality of bins. A velocity of the reflection signal with the highest amplitude may be identified as a reference velocity and the amplitude associated with the reference velocity may be associated with a reference bin (e.g., bin B₀). The one or more other velocities included in the reflection signal may be compared with respect to the reference velocity. Each bin of the velocity profile represents an offset with respect to the reference velocity. A corresponding bin for the one or more other velocities included in the reflection signal may be determined. A determined bin includes an amplitude associated with one of the one or more other velocities included in the reflection signal. For example, a reflection signal may be a reflection signal associated with a UAV. The UAV is comprised of a main body and a plurality of rotors. The velocity of a UAV body may be represented as a reference velocity in the velocity profile. The velocity of a UAV rotor may be represented in a bin offset from the reference velocity. The bin associated with the reference velocity (e.g., B₀) may store an amplitude associated with the velocity of the UAV body. The bin offset from the reference bin (e.g., ±B₁, ±B₂ . . . ±Bₙ) may store an amplitude associated the velocity of a UAV rotor.

A direction of a beam of the phased antenna array may be focused towards a detected object such that a plurality of antenna elements 903 receive a reflection signal from the detected object. The detected object may be associated with a detected security event. A velocity profile for each of the received corresponding reflection signals may be generated. The velocity profile for each of the received corresponding reflection signals may be combined. The combined velocity profile includes the same bins as one of the velocity profiles, but a bin of the combined velocity profile stores a plurality of amplitudes from the plurality of velocity profiles. A maximum amplitude value (peak) may be selected for each bin of the combined velocity profile. The maximum amplitude bin values may be used in a feature vector to classify the object. For example, the feature vector may include the values {B_{0 max}, B₁ max, . . . , B_{n max}}.

Radar system 902 is coupled to processor 913. Radar system 902 may provide the feature vector to processor 913 and the processor 913 may apply the feature vector to one of the machine learning models 905 that is trained to determine whether the object is a UAV or not a UAV. The one or more machine learning models 905 may be trained to label one or more objects. For example, a machine learning model may be trained to label an object as a “UAV” or “not a UAV.” A machine learning model may be trained to label an object as a “bird” or “not a bird.” A machine learning model may be trained to label an object as a “balloon” or “not a balloon.”

The one or more machine learning models 905 may be configured to implement one or more machine learning algorithms (e.g., support vector machine, soft max classifier, autoencoders, naïve bayes, logistic regression, decision trees, random forest, neural network, deep learning, nearest neighbor, etc.). The one or more machine learning models 905 may be trained using a set of training data. The set of training data includes a set of positive examples and a set of negative examples. For example, the set of positive examples may include a plurality of feature vectors that indicate the detected object is a UAV. The set of negative examples may include a plurality of feature vectors that indicate the detected object is not a UAV. For example, the set of negative examples may include feature vectors associated with a balloon, bird, plane, helicopter, etc.

In some embodiments, the output of machine learning model trained to identify UAVs may be provided to one or more other machine learning model that are trained to identify specific UAV models. The velocity profile of a UAV may follow a general micro-Doppler signature, but within the general micro-Doppler signature, different types of UAVs may be associated with different micro-Doppler signatures. For example, the offset difference between a bin corresponding to a baseline velocity and a bin corresponding to a secondary velocity may have a first value for a first UAV and a second value for a second UAV.

The output from the one or more machine learning models 905 may be provided to jammer 911. Jammer 911 may include one or more antennas to transmit a communication disruption signal. For example, a directional antenna (e.g., log periodic antenna) may be used to transmit the communication disruption signal. The communication disruption signal may be configured to disrupt signals at 2.1 GHz and 5.8 GHz. In some embodiments, a dual frequency antenna is used to disrupt both signals. In other embodiments, a first antenna is used to disrupt signals at 2.1 GHz and a second antenna is used to jam signals at 5.8 GHz. Jammer 911 may include a microcontroller. The microcontroller may be configured to receive the output from the one or more machine learning models 905. In response to one of the one or more machine learning models identifying a UAV, the microcontroller may be configured to send a control signal that causes jammer 911 to send a communication disruption signal in the direction of the identified UAV. The jamming system may be configured to temporarily disrupt the communication system of the target UAV (e.g., the target UAV is the detected security event) through the use of a communication disruption signal that is based on a sawtooth wave. A sawtooth wave is a non-sinusoidal wave with sharp ramps going upwards and then suddenly downwards or a non-sinusoidal wave with sharp ramps going downwards and then suddenly upwards. The power of a communication disruption signal at the peak of the sawtooth wave may be sufficient to jam the communications system of the target UAV, but due to the nature of the sawtooth wave, the communications system of the target UAV may be temporarily disabled because the power of the communication disruption signal will suddenly drop and ramp up again. The power of the communication disruption signal may be based on a type of the target UAV. For example, the communication disruption signal may have a first power for a first type of UAV and a second power for a second type of UAV. A set of predefined jamming conditions may have to be met before jammer 911 is configured to transmit the communication disruption signal. The predefined jamming conditions may include an identification of a target UAV and a threshold range between the target UAV and UAV 900. In other embodiments, jammer 911 is a software defined radio and may be configured to jam signals in a frequency range of 400 MHz and 10 GHz.

Interdiction system 907 may receive an indication from jammer 911 that indicates a communication disruption signal is being transmitted. Interdiction system 907 may include a capture net launcher 908, one or more sensors 909, a control system 910, and a tether mechanism 912. A loop of a net may be coupled to a tether mechanism. The tether mechanism 912 may be used to restrain a net on the UAV until the net is deployed. The tether mechanism 912 may include a locking mechanism holds a net in place. A deployed net may be coupled to UAV 900 via a tether (e.g., cable, rope, etc.).

In response to the indication, control system 910 may be configured to monitor signals received from the one or more sensors 909 and/or radar system 902, and control capture net launcher 908 to automatically deploy the capture net when predefined firing conditions are met. One of the predefined firing conditions may include an identification of a target UAV. One of the predefined firing conditions may include a threshold range between the target UAV and UAV 900. One of the predefined firing conditions may include a flight pattern associated with a target UAV. For example, a detected object may be required to be identified as a UAV and identified UAV may be required to be flying in a hovering flight pattern within a threshold distance before the net may be fired. In some embodiments, after a capture net is deployed, control system 910 provides to jammer 911 a control signal that causes jammer 911 to stop a transmission of the communications disruption signal.

The one or more sensors 909 may include a global positioning system, a light detection and ranging (LIDAR) system, a sounded navigation and ranging (SONAR) system, an image detection system (e.g., photo capture, video capture, UV capture, IR capture, etc.), sound detectors, one or more rangefinders, etc. The one or more sensors 909 and/or the visual detection system 914 may sense a flight pattern associated with a target UAV. In the event the one or more sensors 909 and/or the visual detection system 914 detect the target UAV is flying in a hovering flight pattern, the control system 910 may provide a control signal to tether mechanism 912 to release the locking mechanism and a control signal to capture net launcher 908 to fire the net.

When the interdiction control system 910 determines that the object is a target UAV, it may also determine if the target UAV is an optimal capture position relative to the defending UAV. If the relative position between the target UAV and the defending UAV is not optimal, interdiction control system 910 may provide a recommendation or indication to the remote controller of the UAV. Interdiction control system 910 may provide or suggest course corrections directly to the processor 911 to maneuver the UAV into an ideal interception position autonomously or semi-autonomously. Once the ideal relative position between the target UAV and the defending UAV is achieved, interdiction control system 910 may automatically trigger capture net launcher 908. Once triggered, capture net launcher 908 may fire a net designed to ensnare the target UAV and disable its further flight.

In the event the one or more sensors 909 and/or the visual detection system 914 detect that the target UAV is not flying in a hovering flight pattern after a communication disruption signal is transmitted, the control system 910 may provide a control signal to jammer 911. In response to the control signal from the control system 910, jammer 911 may be configured to increase a power of the communication disruption signal.

The net fired by the capture net launcher may be tethered to UAV 900 via a tether (e.g., cable, rope, etc.). This may allow UAV 900 to move the target UAV to a safe area for further investigation and/or neutralization. Tether mechanism 912 may include a motor that causes a locking mechanism to move. The motor may use a particular amount of current to displace the locking mechanism so that a net may be deployed. The tether mechanism 912 may be configured to keep the locking mechanism in a particular position (e.g., a neutral position) after a net is deployed. The motor may use a particular amount of current to keep the locking mechanism in the particular position. The motor may provide a current signal to control system 910. The current signal profile of the motor may change after the net is deployed. For example, more current may be used by the motor to keep the locking mechanism in the particular position if the net captured a UAV than if the net did not capture a UAV. This current signal profile may be used by control system 910 to determine that the target UAV is captured. This current signal may also be used by control system 910 to sense the weight, mass, or inertia effect of a target UAV being tethered in the capture net and recommend action to prevent the tethered target UAV from causing UAV 900 to crash or lose maneuverability. For example, control system 910 may recommend UAV 900 to land, release the tether, or increase thrust.

When it is determined that the target UAV has been captured, the defending UAV may stop transmitting the communication disruption signal. One problem with communication disruption signals is that they operate in a frequency range associated with a plurality of wireless communication devices. While the directionality of the communication disruption signal may be adjusted, any wireless communications device in the direction of the communication disruption signal that operates in the frequency range of the communication disruption signal will also be jammed. In response to tether mechanism 912 indicating that the target UAV has been captured, jammer 911 may be configured to stop transmitting the communication disruption signal.

In other embodiments, the net is coupled to a pressure sensor. When the net has captured a UAV, the pressure sensor will have a first measurement. When the net has not captured a UAV, the pressure sensor will have a second measurement. The pressure sensor signals may be provided to control system 910, which may use signals to determine whether the target UAV is captured.

Unmanned Aerial Vehicle 900 may include a visual detection system 914. Visual detection system 914 may be comprised of one or more cameras and be used to visually detect a UAV. Visual detection system 914 may visually detect an object and provide image data (e.g., pixel data) to one of the one or more machine learning models 905. A machine learning model may be trained to label an object as “a UAV” or “not a UAV” based on the image data. For example, a set of positive examples (e.g., images of UAVs) and a set of negative examples (e.g., images of other objects) may be used to train the machine learning model. Visual detection system 914 may be configured to determine that the flight pattern of the object is unrestrained or that the flight pattern of the object is restrained (e.g., hovering pattern).

Processor 913 may use the output from the machine learning model trained to label an object as a UAV based on the radar data and the machine learning model trained to label the object as a UAV based on image data to determine whether to activate the interdiction system 907. Processor 913 may activate interdiction system 907 in the event the machine learning model trained to label an object as a UAV based on radar data and the machine learning model trained to label the object as a UAV based on image data both indicate that the object is a UAV.

UAV 900 may use radar system 902 to detect an object that is greater than a threshold distance away. UAV 900 may use camera system 914 to detect an object that is less than or equal to the threshold distance away. UAV 900 may use both radar system 902 and camera system 914 to confirm that a detected object is actually a UAV. This reduces the number of false positives and ensures that the capture active mechanism is activated for actual UAVs.

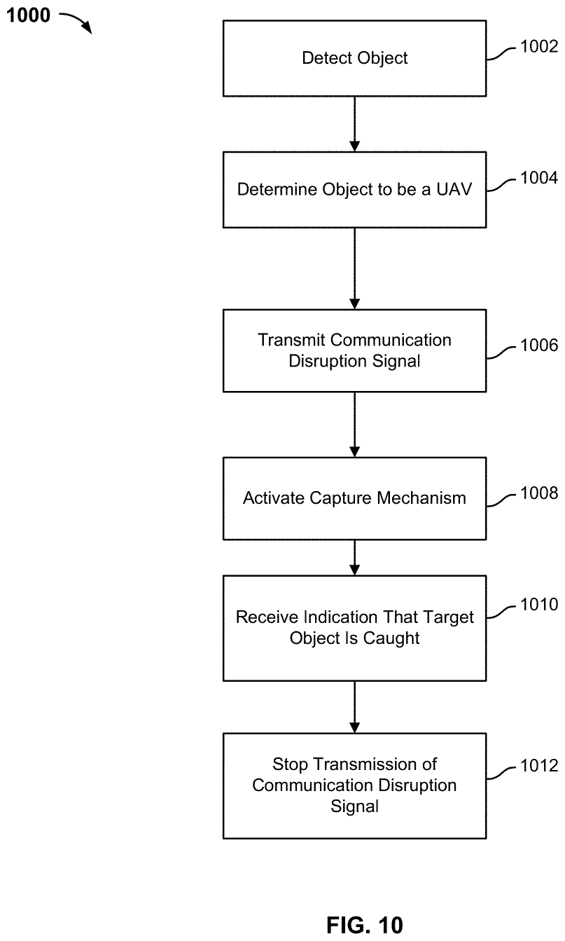

FIG. 10 is a flow chart illustrating an embodiment of a process for capturing a target object. The target object may be associated with a detected security event. In the example shown, process 1000 may be performed by a UAV, such as UAV 900. In some embodiments, process 1000 is implemented as part of step 210 of process 200.

At 1002, an object is detected. The object may detected using one or more of a radar system, a light detection and ranging (LIDAR) system, a sounded navigation and ranging (SONAR) system, a visual detection system (e.g., photo capture, video capture, UV capture, IR capture, etc.), sound detectors, one or more rangefinders, etc.

At 1004, the detected object is determined to be a UAV. The UAV may be associated with a detected security event. The detected object may be determined to be a UAV based on image data associated with a visual detection system. For example, image data (e.g. pixels) may be provided to a machine learning model that is trained to output a label based on the image data. A machine learning model may be trained output a label of “UAV” or “not a UAV.” The machine learning model may be trained using a set of positive examples and a set of negative examples. The set of positive examples may include image data associated with a UAV, e.g., images of UAVs. The set of negative examples may include image data associated with objects that are not a UAV (e.g., bird, airplane, balloon, person, etc.) The machine learning model may be trained to output a label of “UAV” in the event the image data of the detected object is similar to the set of positive examples.

In other embodiments, the detected object may be determined to be a UAV based on a micro-Doppler signature associated with the detected object. A radar system may receive one or more reflections from the detected object. A detected object may be comprised of a plurality of components. The plurality of components may have different velocities. For example, a radar system may transmit a transmission signal towards a car. The transmission signal may be reflected off the body of the car as well as the wheels of the car. A velocity of the body of the car may be different than a velocity of a wheel when the car is moving. A radar system may transmit a transmission signal towards a UAV. The transmission signal may reflect off the body of the UAV as well as each of the rotors of the UAV. A velocity of the body of the UAV may be different than a velocity of each of the rotors. The velocities of the different components may be determined based on the one or more reflected signals. An object may be determined based on the relative velocities of the different components. For example, the velocity associated with a body of a car may have a particular velocity offset from the wheels of the car. The velocity associated with a body of a UAV may have a particular velocity offset from the rotors of the UAV. The velocity profile of different objects may represent a micro-Doppler signature of an object and used to determine a detected object to be a UAV.

At 1006, a communication disruption signal is transmitted. A power of the communication disruption signal may be based on a distance between a target UAV and a defending UAV. In the event the distance is less than a first threshold, the communication disruption signal may have a first power. In the event the distance is greater than or equal to the first threshold, the communication disruption signal may have a second power.

The communication disruption signal may be based on a sawtooth wave. The communication disruption signal is configured to confuse the target UAV such that the target UAV hovers over a particular area instead of freely flying around. The communication disruption signal is configured to block or interfere with the wireless communications of the target UAV. Some UAVs are configured to return to a start position in the event its wireless communication system is are blocked and/or interfered. The communication disruption signal is configured such that the wireless communication systems of the target UAV is temporarily blocked and/or interfered, but then return back to normal temporarily, and temporarily blocked and/or interfered, and then again return back to normal temporarily, and so forth. The communication disruption signal prevents the target UAV from determining that its communication systems is blocked and/or interfered because the duration in which the communications systems is blocked and/or interfered is less than the duration that causes the target UAV to implement its communication failure procedure (e.g., return back to the start position.).

The communication disruption signal may be transmitted in the event a set of predetermined conditions are satisfied. The set of predetermined conditions may include a detected object being determined to be a UAV and the UAV being within a threshold range. In the event the set of predetermined conditions are satisfied, a microcontroller of the communication disruption signal generator may provide a control signal that closes a switch such that the communication disruption signal is transmitted.

Different models of target UAV may have different communication failure procedures. For example, a first UAV may implement a communication failure procedure after communications are disabled for a threshold period of time (e.g., five seconds). A second UAV may implement a communication failure procedure that tries to re-establish communication for a threshold number of times. In the event communication cannot be re-established after the threshold number of times, the second UAV may be configured to implement the communication failure procedure. The waveform of the communication disruption signal may be adjusted based on the particular type of target UAV. For example, the ramp time of the communication disruption signal may be increased/decreased based on the type of the target UAV. The strength of the communication disruption signal may also be increased/decreased based on the particular type of target UAV. The frequency of the communication disruption signal may be modified to the particular type of target UAV.

At 1008, a capture mechanism is activated. The capture mechanism of UAV may include an interdiction system that enables the UAV to capture, disable, and/or transport a target UAV away from a particular area. The interdiction system may be comprised of a capture net launcher, an interdiction sensor package, and an interdiction control system. The interdiction control system may monitor signals received from the interdiction sensor package and control the capture net launcher to automatically deploy the capture net when one or more predefined conditions are met. The one or more predefined conditions may include a target UAV is detected, the target UAV is within a threshold distance, and the target UAV is currently hovering over a particular area because the communications system of the target UAV is blocked and/or interfered.

The interdiction sensor module may include range finding sensors, such as RADAR rangefinders, LIDAR rangefinders, SONAR based rangefinders, ultrasonic based rangefinders, stereo-metric cameras, or another other range finding sensor.

At 1010, an indication that the target object is caught is received. The net fired by the capture net launcher may be tethered to a defending UAV via a tether. This may allow UAV to move the target UAV to a safe area for further investigation and/or neutralization. A tether mechanism may include a motor that causes a locking mechanism to move. The motor may use a particular amount of current to displace the locking mechanism so that the net may be deployed. The tether mechanism may be configured to keep the locking mechanism in a particular position after a net is deployed. The motor may use a particular amount of current to keep the locking mechanism in the particular position. The motor may provide a current signal to control system. The current signal profile of the motor may change after the net is deployed. For example, more current may be used by the motor to keep the locking mechanism in the particular position if the net captured a UAV than if the net did not capture a UAV. This current signal may be used by control system to determine that the target UAV is captured. This current signal may also be used by control system to sense the weight, mass, or inertia effect of a target UAV being tethered in the capture net and recommend action to prevent the tethered target UAV from causing UAV to crash or lose maneuverability. For example, control system may recommend UAV to land, release the tether, or increase thrust.

In other embodiments, the net is coupled to a pressure sensor. When the net has captured a UAV, the pressure sensor will have a first measurement. When the net has not captured a UAV, the pressure sensor will have a second measurement. The pressure sensor signals may be provided to the interdiction control system, which may use the signals to determine whether the target UAV is captured.

At 1012, a transmission of the communication disruption signal is stopped. When it is determined that the target UAV has been captured, the defending UAV may stop transmitting the communication disruption signal. One problem with communication disruption signals is that they operate in a frequency range associated with a plurality of wireless communication devices (e.g., cell phones). While the directionality of the communication disruption signal may be adjusted, any wireless communications device in the direction of the communication disruption signal that operates in the frequency range of the communication disruption signal will also be jammed. In response to the tether mechanism indicating the target UAV has been captured, the defending UAV may be configured to stop transmitting the communication disruption signal. This may minimize the amount of time the other wireless communication devices are also jammed.

In some embodiments, the transmission of the communication disruption signal is stopped after the capture mechanism is activated without receiving an indication that the target object is caught (e.g., step 1010 is optional).

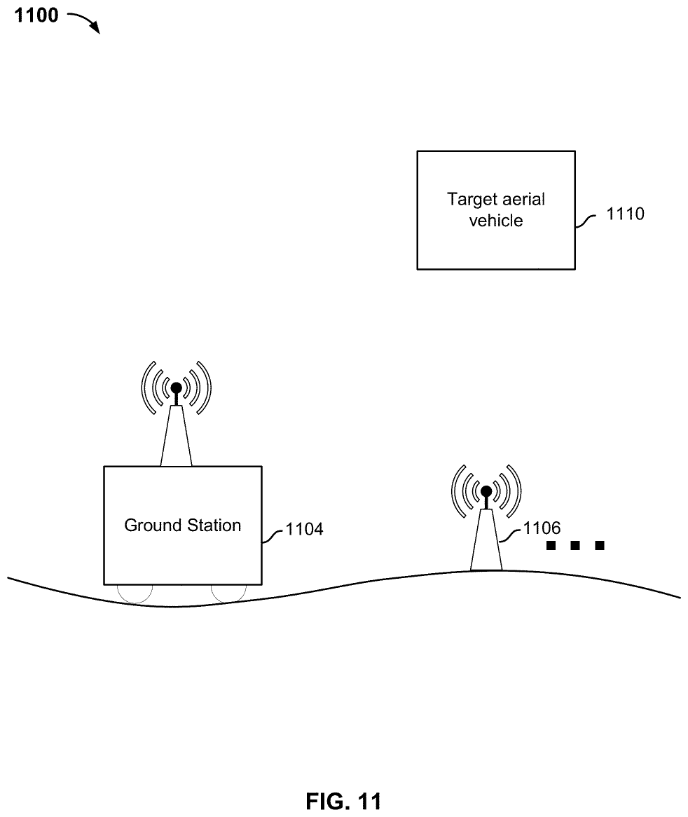

FIG. 11 is a block diagram illustrating an embodiment of a system for managing an airspace. In some embodiments, system 1100 depicts an example of a system for detecting security events.

Ground station 1104 may include one or more sensors utilized to detect a location of aerial vehicles within an airspace. For example, ground station 1104 may include one or more 2D/3D radars, signal detector antennas (e.g., monitor signal communication between UAV and remote operator), cameras, wireless communication sensors, and/or LIDAR sensors monitoring the airspace. Ground station 1104 may also receive information from one or more other ground-based sensors. One example of the ground-based sensor is ground-based sensor 106. Examples of ground-based sensor 1106 may include one or more of radars, antennas, cameras, wireless communication sensors, and/or LIDAR sensors.

An unauthorized aerial vehicle can be detected (e.g., using sensors of ground station 1104 and/or ground-based sensor 1106). An example of the unauthorized aerial vehicle is target aerial vehicle 1110 (e.g., a drone, a multirotor aircraft, an airplane, a UAV, a helicopter, or any other vehicle capable of flight). In some embodiments, ground station 1104 is included in a mobile platform that is able to be transported to different physical locations. For example, ground station 1104 is on a movable platform with wheels that may be towed or may include an engine to also serve as a vehicle.

In the example implementation, the telecommunications structure of ground station 104 is configured to receive and transmit signals. More specifically, the transmission protocol may include but is not limited to RF, wireless/Wi-Fi, Bluetooth/Zigbee, cellular, and others. The telecommunications structure is configured to receive multiple streams of communication in different protocols, and to combine and thread the different communication inputs. Further, the telecommunications structure may also be configured to receive low altitude signals, such as light transmission in various colors, intensities, patterns and shapes, which may be used to identify a target drone.

The identity of the target aerial vehicle may be further compared and associated with a user by additional criteria, such as authentication of user equipment. For example, if a target drone is identified as friend or foe, at a first level of authentication, an owner or user associated with a mobile computing device may receive a query, such as a text message, email or other communication. The user may be required to authenticate ownership, operation, control, or other association with the target drone, prior to the target drone being cleared for operation. Alternatively, if the first level of authentication does not indicate that the target drone is a “friend,” further targeting and interdiction may occur. Similarly, if the second level of authentication does not result in the user providing sufficient factors or clearances to confirm association with the target drone, even if the target drone is determined to be a “friend” at the first authentication stage, that classification may be converted to “foe,” or the “friend” determination may not be implemented, if the second level or factor of authentication does not result in a confirmation that the user is associated with the target drone, and that the association meets the criteria for “friend” status.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method, comprising:
receiving an indication of a detected security event;
selecting one or more sensors based on the detected security event;
using the selected sensors to detect additional information associated with a protected airspace associated with the detected security event;
determining a risk level assessment associated with the detected security event based at least in part on the additional information detected using the selected sensors; and
automatically invoking a response based on the determined risk level assessment.

2. The method of claim 1, wherein the indication of the detected security event includes an initial location of the detected security event.

3. The method of claim 1, wherein the detected additional information includes a refined location of the detected security event.

4. The method of claim 1, wherein the indication of the detected security event is received is from at least one of the sensors included in a first layer of sensors.

5. The method of claim 4, wherein the one or more sensors are selected from a second layer of sensors.

6. The method of claim 5, wherein the one or more sensors are selected from a second layer of sensors based on a corresponding availability of the one or more sensors.

7. The method of claim 5, wherein the one or more sensors are selected from a second layer of sensors based on whether the one or more sensors are capable of detecting the detected security event.

8. The method of claim 1, wherein the one or more sensors are selected based on corresponding sensor information stored in a sensor information database.

9. The method of claim 8, wherein the sensor information database stores corresponding sensor information associated with a plurality of registered sensors.

10. The method of claim 1, wherein selecting one or more sensors based on the detected security event comprises selecting a primary sensor from a set of available sensors.

11. The method of claim 10, wherein selecting one or more sensors based on the detected security event comprises selecting one or more secondary sensors from a set of available sensors.

12. The method of claim 1, wherein determining a risk level assessment associated with the detected security event comprises:
determining corresponding feature values associated with a plurality of features based in part on the detected additional information;
applying a feature vector comprised of at least some of the determined corresponding feature values to a machine learning model; and
outputting the risk level assessment associated with the detected security event.

13. A system, comprising:
a processor; and
a memory coupled with the processor, wherein the memory is configured to provide the is processor with instructions which when executed cause the processor to:
receive an indication of a detected security event;
select one or more sensors based on the detected security event;
use the selected sensors to detect additional information associated with a protected airspace associated with the detected security event;
determine a risk level assessment associated with the detected security event based at least in part on the additional information detected using the selected sensors; and
automatically invoke a response based on the determined risk level assessment.

14. The system of claim 13, wherein the indication of the detected security event includes an initial location of the detected security event.

15. The system of claim 13, wherein the indication of the detected security event is received from at least one of the sensors included in a first layer of sensors.

16. The system of claim 15, wherein the one or more sensors are selected from a second layer of sensors.

17. The system of claim 16, wherein the one or more sensors are selected from a second layer of sensors based on a corresponding availability of the one or more sensors.

18. The system of claim 16, wherein the one or more sensors are selected from a second layer of sensors based on whether the one or more sensors are capable of detecting the detected security event.

19. The system of claim 13, wherein the one or more sensors are selected based on corresponding sensor information stored in a sensor information database.

20. A computer program product, the computer program product being embodied in a non-transitory computer readable storage medium and comprising computer instructions for:
receiving an indication of a detected security event;
selecting one or more sensors based on the detected security event;
using the selected sensors to detect additional information associated with a protected airspace associated with the detected security event;
determining a risk level assessment associated with the detected security event based at is least in part on the additional information detected using the selected sensors; and
automatically invoking a response based on the determined risk level assessment.
